(19) United States
(12) Patent Application Publication
(10) Pub. No.: US 2002/0162444 A1
(43) Pub. Date: Nov. 7, 2002

(54) Method and system for playing music-related files

(76) Inventors: Kang-Yeh Yu, Taipei (TW); San-Lan Huang, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/848,329

(22) Filed: May 4, 2001

(51) Int. Cl. G06F 9/00; G06F 9/24; G06F 9/445; G06F 15/177; G06F 1/26; G06F 1/28; G06F 1/30

(52) U.S. Cl. 84/601; 713/2; 713/300

(57) ABSTRACT

A computer system has a memory area, a processor, and at least one music-related file. The computer system is powered on long enough to load music-playing software into memory. Then, all devices not needed to play the music-related file are either shut off, or powered down to a lower power-consumption level. A CPU throttle may also be employed to further reduce power consumption. The computer system then processes and plays the music-related files.

### BACKGROUND OF THE INVENTION

1. Field of the Invention

The present invention relates to digital file access. More specifically, the present invention discloses a method and system for playing music-related files on a computer system.

2. Description of the Prior Art

Digital audio is now a music industry standard. With many channels for converting any form of audio to a digital file, an ability to encode and compress digital audio files, and many hardware options for storing large numbers of compressed digital audio files, users now face very few limitations in accessing their favorite music.

One limitation to the access of digital audio files lies in an ability to access digital audio files from a portable device. A suitable solution should be inexpensive, and power saving.

Please refer to FIG. 1 and FIG. 2. FIG. 1 is a perspective diagram of a notebook computer 10 according to the prior art. FIG. 2 is a block diagram of the notebook computer 10. The notebook computer 10 has an MP3 chip 11, a plurality of buttons 12 for sending signals to the MP3 chip 11, a battery 14, a CD-ROM 16, and a plurality of speakers 18. The notebook computer 10 also has an audio output jack 19 for headphones, external speakers, etc. The battery 14 powers the MP3 chip 11 and the CD-ROM 16. The MP3 chip 11 is connected by internal bus circuitry 11a to the CD-ROM 16, and is also connected to the plurality of speakers 18 and the audio jack 19. The MP3 chip 11 is capable of controlling the CD-ROM 16 via the bus circuitry 11a, and decoding MP3 files 16a on the CD-ROM 16 to send an analog audio signal to the plurality of speakers 18, or to the audio jack 19.

Because the MP3 chip 11 does not require an operating system to play the MP3 audio files 16a, the chip 11 saves a considerable amount of power, as devices normally needed for the full operation of the notebook computer 10 are not used. The MP3 chip 11 effectively converts the notebook computer 10 into a standalone MP3-enabled device. However, while using the MP3 chip 11 allows users to listen to music files 16a from a portable device, and even saves a lot of battery power by not booting an operating system, the chip 11 is still rather expensive.

### SUMMARY OF THE INVENTION

It is therefore a primary objective of the present invention to provide a method of playing music-related files that saves power and reduces costs.

Briefly summarized, the preferred embodiment of the present invention discloses a method of playing music-related files on a computer system. Having received a signal to play music from a plurality of buttons on the computer system, the computer system is booted up from a special partition. Upon loading appropriate music-playing software from the special partition, all hardware that is no longer needed to play music is brought to a lower power consumption state, or even shut off completely. Music is then played from a memory system in the computer.

It is an advantage of the present invention that a software implementation is used, which makes the present invention implementation less expensive to manufacture. Cost-savings are thus passed on to the user, while battery power consumption is kept to a bare minimum.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a perspective diagram of a notebook computer according to the prior art.

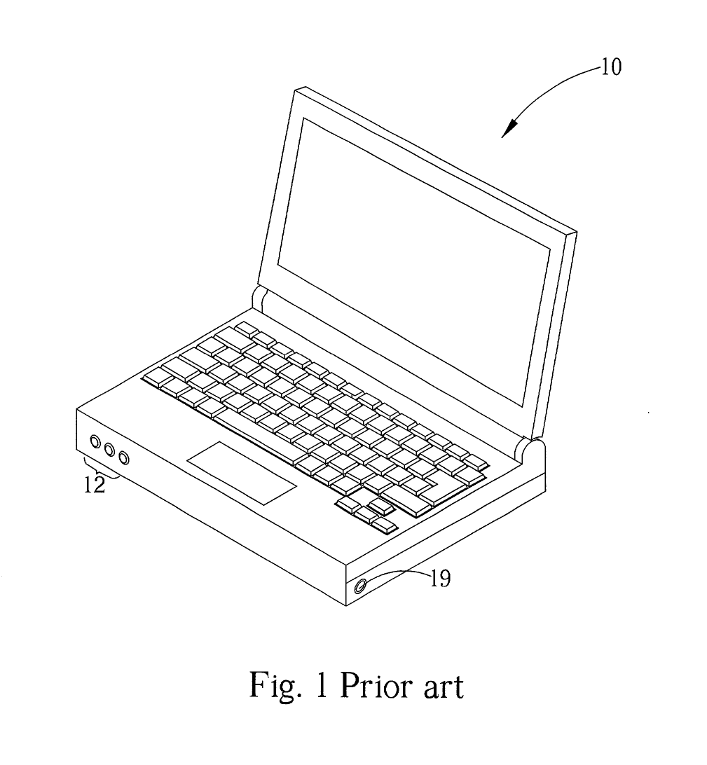

FIG. 2 is a block diagram of the prior art method as implemented for the notebook computer of FIG. 1.

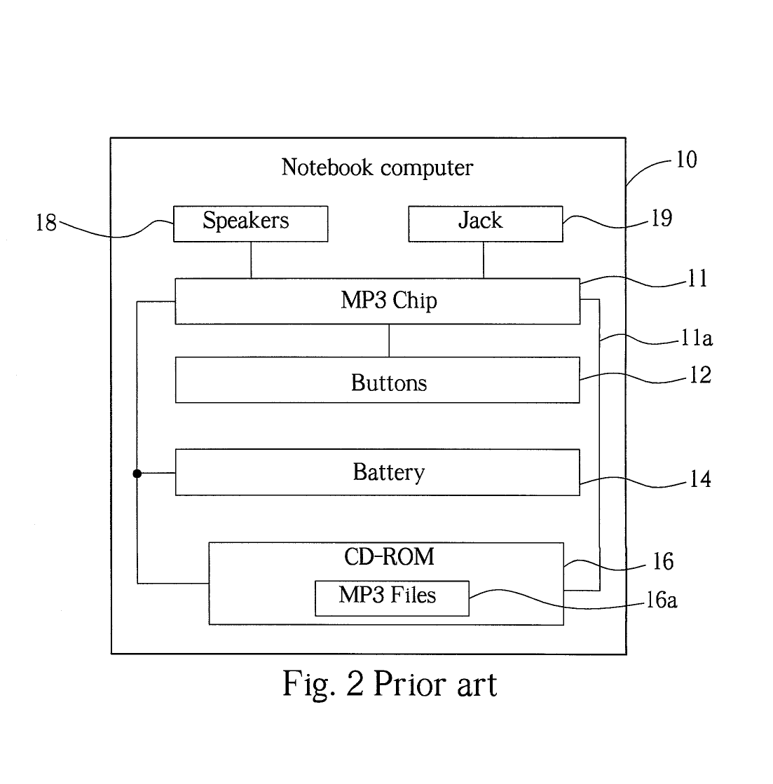

FIG. 3 is a perspective diagram of a computer system according to the present invention.

FIG. 4 is a block diagram of the computer system of FIG. 3.

FIG. 5 is a flow chart of the present invention.

### DETAILED DESCRIPTION OF THE PREFERRED EMBODIMENT

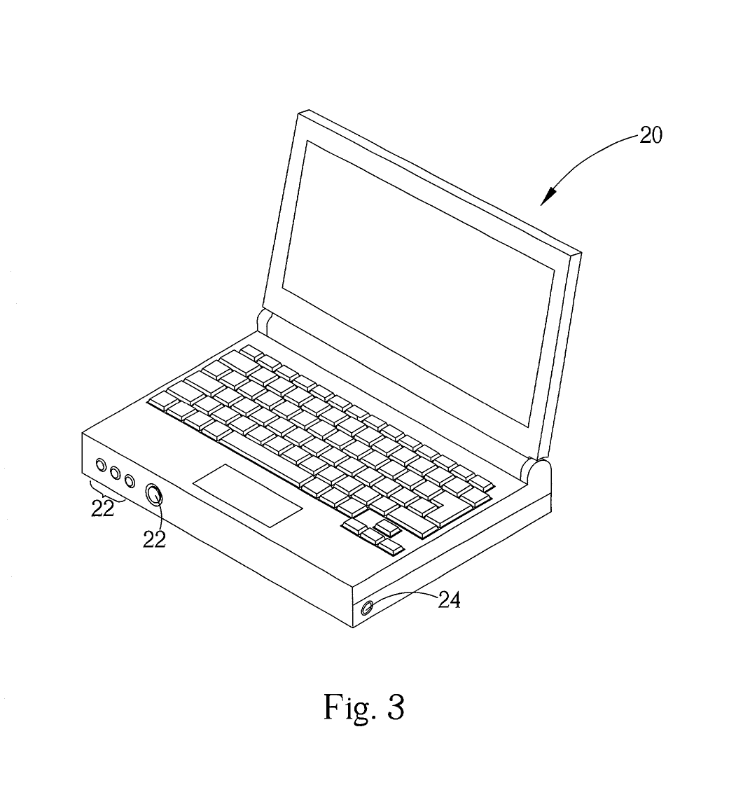

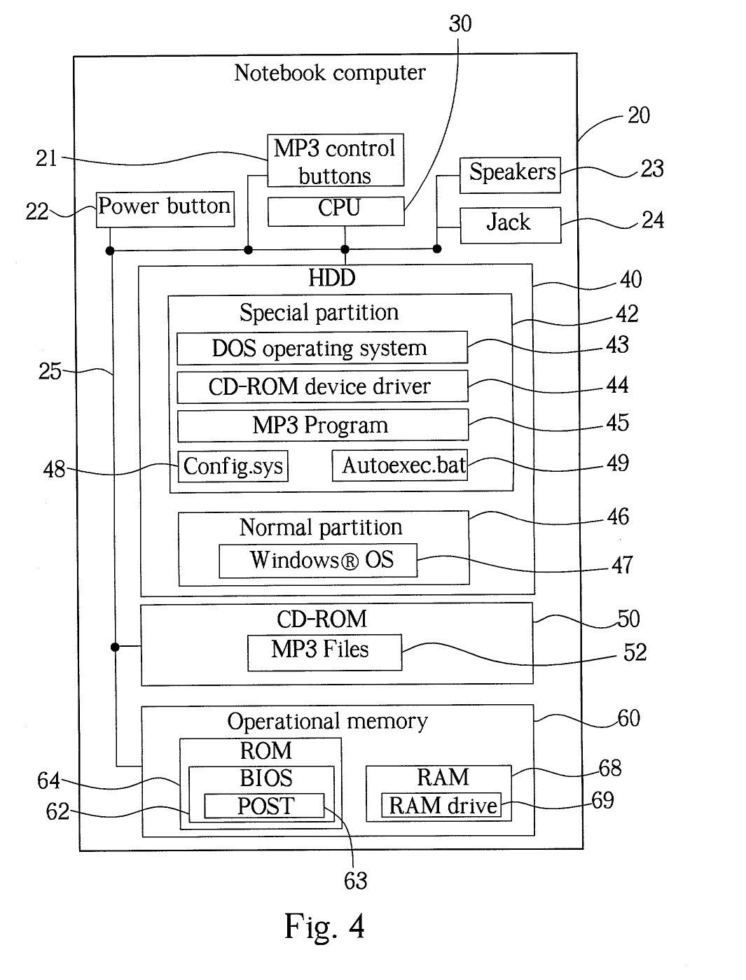

Please refer to FIG. 3 and FIG. 4. FIG. 3 is a perspective diagram of a computer system 20 that utilizes the present invention method. FIG. 4 is a block diagram of the computer system 20. The computer system 20 comprises a plurality of MP3 control buttons 21, a normal power button 22, a processor (CPU) 30 for executing programs, a hard disk drive (HDD) 40 as a first memory system, a CD-ROM 50 as a second memory system, and operational memory 60. The operational memory 60 includes ROM 64 and RAM 68. The RAM 68 is volatile working memory for the CPU 30. The ROM 60 is non-volatile memory for the CPU 30, and includes Basic Input/Output System (BIOS) program code 62. The BIOS code 62 is used by other programs executed by the CPU 30 from the RAM 68 for low-level functions. A Power On Self Test (POST) program 63 resides in the BIOS 62, and is executed by the CPU 30 when the notebook computer 20 is turned on. A bus 25 electrically connects the CPU 30 to the HDD 40, CD-ROM 50, operational memory 60, power button 22 and MP3 control buttons 21. The HDD 40 comprises a special partition 42 for booting DOS, and a normal partition 46 for booting Microsoft® Windows®. The special partition 42 comprises a DOS operating system 43, a CD-ROM device driver 44, an MP3 program 45 for playing MP3 music files, a pre-configured autoexec.bat file 49, and a pre-configured config.sys file 48. The autoexec.bat file 49 and config.sys file 48 may be configured by the manufacturer of the notebook computer 20, or by a user. The normal partition 46 comprises a Windows® operating system 47. Please note that although the present invention is described here for a rather complex computer system, such as a notebook computer, in general, any computer system having a first permanent memory system, such as the HDD 40, and a processor 30, can employ the present invention. Also, it should be clear to one skilled in the art that other combinations of operating systems are possible for the present invention method. Those noted above are simply the most commonly used for conventional personal computer (PC) systems. Additionally, the DOS operating system 43 has the advantage of being a relatively small operating system, and thus requires little space in the special partition 42. The notebook computer 20 also includes speakers 23 and an audio output jack 24.

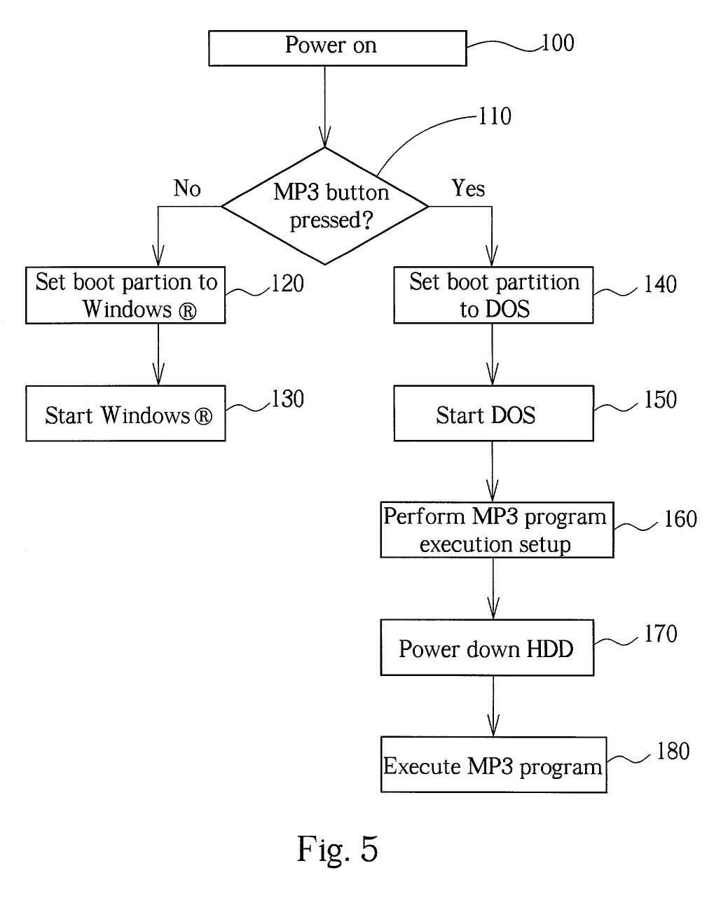

Please refer to FIG. 5, with reference to FIGS. 3 and 4. FIG. 5 is a flow chart outlining the method of the present invention. The method is introduced for the notebook computer system described above. Steps for the present invention method include:

Step 100: The notebook computer 20 is powered on. This may be due to either a user pressing the normal power button 22, or one of the MP3 control buttons 21. Proceed to step 110.

Step 110: The POST program 63 within the BIOS 62 is executed and self-checks the notebook computer 20. Upon a successful completion of the self-test procedure, the BIOS 62 determines if the power-on status of the notebook computer 20 was due to the normal power button 22, or one of the MP3 control buttons 21. If one of the MP3 control buttons 21 was pressed, then proceed to step 140. Otherwise, proceed to step 120.

Step 120: The normal power-on button 22 was pressed. Set the boot partition to the normal partition 46 and hide the special partition 42. Proceed to step 130.

Step 130: Perform an operating system boot from the boot partition, which is the normal partition 46. A normal Windows® operating system 47 boot procedure is thus performed.

Step 140: An MP3 control button 21 was pressed. Set the boot partition to the special partition 42 and hide the normal partition 47. Proceed to step 150.

Step 150: Boot from the boot partition. This results in the DOS operating system 43 being booted on the special partition 42. Proceed to step 160.

Step 160: The DOS operating system 43 parses the config.sys file 48 and then the autoexec.bat file 49. The config.sys file 48 is pre-configured to cause the DOS operating system 43 to create a RAM drive 69 from available RAM 68, and to load the CD-ROM device driver 44 so that the DOS operating system 43 may access the CD-ROM drive 50. The autoexec.bat file is pre-configured to cause the DOS operating system 43 to load the MP3 program 45 into the RAM drive 69. Proceed to step 170.

Step 170: The pre-configured autoexec.bat file 49 further causes the HDD 40 to power down. Additionally, any other devices or equipment not required by the MP3 program 45 to play MP3 files 52 on the CD-ROM drive 50 are also powered down or placed into a low-power idle state. For example, video circuitry (VGA) and PCMCIA circuitry may all be powered down or idled. If possible, the CPU 30 is also throttled so that the CPU 30 executes at a slower processing speed to conserve power. Proceed to step 180.

Step 180: The pre-configured autoexec.bat file 49 causes the MP3 program 45 resident in the RAM drive 69 to be executed. The MP3 program 45 begins playing the MP3 files 52 on the CD-ROM 50. The speakers 23 or the jack 24 may be used to listen to the MP3 files 52. Power should not be delivered to the speakers 23 if the speakers 23 are not being used to listen to the MP3 files 52.

As shown, the method begins when a user sends a signal by way of either the MP3 control buttons 21 or the normal power button 22. The BIOS 62 checks an embedded controller to determine the nature of the button press, then sets the boot partition depending on whether the signal came from the MP3 control buttons 21 or the normal power button 22. Thus, the BIOS 62 has a built-in boot determination program functionality. If the signal came from the normal power button 22, then the BIOS performs a normal boot to Windows®. Otherwise, the boot partition is set to the special partition 42, and the normal partition 46 is hidden. Note that the special partition 42 can be much smaller than the normal partition 46, because the special partition 42 only needs space to hold DOS 43, the CD-ROM device driver 44, and the MP3 program 45. During the Power On Self Test 63, the CPU 24, cache, operational memory 60, northBridge, southBridge, CD-ROM 26, HDD 40, and audio hardware are all powered on. When booting DOS 43, the start-up file config.sys file 48 will load the CD-ROM driver 44. The other DOS-based start-up file autoexec.bat file 49 will then call the MP3 program 45, which will reside in a RAM drive. During execution, the MP3 program 45 powers down, or shuts off, all hardware not necessary for playing MP3 music files, then plays the MP3 files 52 on the CD-ROM 50. The hardware shut down by the MP3 program 45 includes the HDD 40, and may also include such devices as the VGA, PCMCIA circuitry, etc. At this time, the CPU 30 may also be throttled, meaning the CPU 30 is run at a lower clock speed, thereby saving power. CPU throttling is a very common feature in notebook computers.

Though not a main feature of the present invention, if the computer is already booted to the normal partition operating system 47, such as Windows®, a press of the MP3 buttons will bring up a normal MP3 file playing application to play MP3 music files. This would be analogous to the user starting an MP3 program from the operating system 47 of the normal partition 46. Supporting such functionality requires an appropriate device driver for the normal partition operating system 47, and is well known in the art.

In contrast to the prior art, the present invention does not require an expensive, dedicated MP3 chip. The present invention, by using a software implementation, accomplishes the same functionality of the prior art, while ensuring that a minimum of power is consumed. Additionally, as a software implementation is used, greater flexibility is made possible by the present invention, as software is inherently easier to upgrade than hardware.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for playing music-related files on a computer system, the computer system comprising:
a first memory system for storing at least a first operating system, and a music playing program for playing music-related files; and
a processor for executing the first operating system and the music playing program;
the method comprising:
causing the processor to boot the first operating system so that the processor executes the first operating system;
adjusting power consumption of a first set of hardware in the computer system, the first set of hardware consisting of hardware that is not required by the music playing program to play the music-related files; and
causing the first operating system to execute the music playing program to play the music-related files;
wherein components in the first set of hardware are in powered down or idled states while the processor executes the music playing program.

2. The method of claim 1 wherein the first memory system is a hard disk.

3. The method of claim 2 further comprising providing at least a first partition and a second partition on the hard disk, first operating system and the music playing program located on the first partition, a second operating system located on the second partition.

4. The method of claim 3 wherein the computer system further comprises a second memory system, the music-related files accessible from the second memory system, and the method comprises powering down or idling the hard disk.

5. The method of claim 4 wherein the second memory system is a CD-ROM player.

6. The method of claim 3 further comprising determining if a normal boot procedure should occur or if a special boot procedure should occur, the normal boot procedure causing the processor to boot the second operating system, the special boot procedure causing the processor to boot the first operating system.

7. The method of claim 6 wherein the computer system further comprises a power-on button and a music-playing button, and if the power-on button is pressed to turn on the computer system, the normal boot procedure occurs, and if the music-playing button is pressed to turn on the computer system, then the special boot procedure occurs.

8. The method of claim 6 further comprising hiding the second partition when performing the special boot procedure, and hiding the first partition when performing the normal boot procedure.

9. The method of claim 3 wherein the first partition is smaller than the second partition.

10. The method of claim 1 wherein the processor is capable of running at a selectable processing speed, and the method further comprises causing the processor to run at a processing speed that requires less electrical power than a normal processing speed.

11. The method of claim 1 wherein the first operating system automatically executes a start-up file, and the method further comprises providing the start-up file configured to cause execution of the music-playing program.

12. The method of claim 1 wherein the music-playing program is capable of playing MP3 files.

13. A computer system comprising:
a power-on button;
a music button for indicating that music-related files are to be played by the computer system;
a first memory system comprising:
a special partition comprising a first operating system to be booted when the music button is activated, and a music playing program for playing the music-related files; and
a normal partition comprising a second operating system to be booted when the power-on button is activated;
a non-volatile memory system for storing at least a boot determination program, the boot determination program utilizing an activation state of the music playing button or power-on button to determine if the first operating system or the second operating system should be booted;
a power-adjusting program for adjusting power consumption of the computer system by adjusting power consumption of a first set of hardware in the computer system, the first set of hardware consisting of hardware that is not required by the music playing program to play the music-related files; and
a processor capable of executing the first operating system, the second operating system, the boot determination program, the music playing program, and the power-adjusting program;
wherein when the computer system is in a power-off state and the music playing button is activated, the processor is caused to execute the boot determination program, the boot determination program causes the first operating system to be booted, the music playing program to be executed, and the the power-adjusting program to be executed.

14. The computer system of claim 13 wherein the first memory system is a hard disk.

15. The computer system of claim 14 further comprising a second memory system, the music-related files accessed from the second memory system.

16. The computer system of claim 15 wherein the second memory system is a CD-ROM player.

17. The computer system of claim 13 wherein the special partition is smaller than the normal partition.
